(19) United States
(12) Patent Application Publication
(10) Pub. No.: US 2017/0235326 A1
(43) Pub. Date: Aug. 17, 2017

(54) EMERGENCY HAND CRANK DRIVE FOR A SHAFT THAT IS TO BE MADE TO ROTATE

(71) Applicant: Hubert KOSCHINAT, Hösbach (DE)

(72) Inventor: Hubert KOSCHINAT, Hösbach (DE)

(21) Appl. No.: 15/503,168

(22) PCT Filed: Jul. 28, 2015
(86) PCT No.: PCT/DE2015/000392

§ 371 Date: Feb. 10, 2017

(30) Foreign Application Priority Data
Aug. 11, 2014 (DE) 10 2014 011 778.2

(51) Int. Cl. G05G 1/08; B60S 9/08; F16D 3/26

(52) U.S. Cl. CPC G05G 1/08; F16D 3/26; B60S 9/08; F16D 7/00

(57) ABSTRACT

Emergency hand crank drive consisting of a load shaft that is to be made to rotate, and a crank arm hingedly connected to said load shaft, and a coupling piece on said load shaft and a catch, which is fixedly connected to said crank arm and which has a shape that is complementary to the shape of said coupling piece and which can be releasably connected to said coupling piece, whereby a rotary sliding piece is mounted on said load shaft in such a way as to be movable in the longitudinal direction of said load shaft and be rotatable around the longitudinal direction thereof and said crank arm is hingedly secured to said rotary sliding piece.

The invention is related to an emergency hand crank drive consisting of a load shaft that is to be made to rotate, and a crank arm hingedly connected to said load shaft, and a coupling piece on said load shaft and a catch, which is fixedly connected to said crank arm and which has a shape that is complementary to the shape of said coupling piece and can be releasably connected to said coupling piece.

In the current state of the art, motors, primarily electric ones, are increasingly used for driving a device and for adjusting a mechanical appliance. But if the power supply to the engine or the engine itself fails, a manually operated crank is a very economical alternative for emergency operation.

The patent DE 855 187 describes that a crank arm is arranged in an articulated manner on a load shaft which is to be rotated. A claw-like catch is rigidly connected to the crank arm and, in the event of an emergency, the catch engages in a complementary coupling member, which is fixedly mounted on the load shaft. Because this connection between the catch and the coupling piece is detachable, but the crank arm is still articulatedly connected to the load shaft in this state, the crank arm can be manually operated again at very low cost and torque transmitted to the load shaft. As an alternative to the crank arm, the load shaft is driven by a motor which is connected to it by a coupling piece

The decisive disadvantage of DE 855 187 is that the crank arm in an unused state can still remain in its operating position. Its previously very desirable, good accessibility then becomes a serious disadvantage because, in the case of being driven with a motor, the risk of collisions with the freely rotating crank, and thus of injuries of the operating personnel, greatly increases. A disadvantage is also that a relatively large operational space is required, which may be urgently required for other functions.

Another disadvantage is that a further coupling piece is required for the operation with a motor, for which the load shaft must be extended accordingly.

On this background, the invention has given itself the task of developing a hand crank drive for an emergency, which avoids the described disadvantages and which—for that purpose—can be removed out of its operating position so far that it only requires a relatively small space, but remains coupled with the load shaft, so that it can be returned into its operating position quickly and with little effort.

As a solution, the invention teaches that a rotary sliding piece is mounted on the load shaft in such a way as to be movable in the longitudinal direction of said load shaft and to be rotatable about the longitudinal direction thereof and the crank arm is hingedly secured to said rotary sliding piece. In most cases a handle is fastened to the crank arm and oriented perpendicular thereto. They both together form the emergency hand crank.

In its simplest embodiment, the rotary sliding piece is a sleeve or hollow cylinder, which concentrically encompasses the load shaft. As a result, it can be shifted on the load shaft in the axial direction.

If the load shaft is rotated, e.g. by an external motor, the rotary sliding piece must not follow this rotation, but can remain stationary in its position by sliding on the rotating load shaft. Because the crank arm is articulated to the rotary sliding piece, it is possible to fold the emergency hand crank out of its operating position and push it closer to the apparatus which it has to drive. In its waiting position the emergency hand crank requires considerably less installation space than in its operating position and the risk of a collision with other machine parts or with the operating persons is avoided.

In order to transfer the emergency hand crank out of its waiting position back into its operating position, a shift of the rotary sliding piece on the load shaft and a pivoting of the emergency hand crank is sufficient.

When being designed, the coupling piece can be arbitrarily arranged on the load shaft with respect to the centerline of the shaft, but with the limitation, that the circular movement of the handle and the operating space for the hand and the arm of the user are not affected. If the coupling piece is arranged outside the centerline of the load shaft, its shape is arbitrary and therefore also a circular profile can be used.

However, the invention prefers that the coupling piece is arranged concentrically on the centerline of the load shaft. In this case, any non-round profile or shape of the end piece of the load shaft is suitable as a coupling piece, as it is known, for example, from screw heads. Well-known and well-suited is a square, but it is also possible to have a triangle, a hexagon or a multi-spline. Other alternatives to this are a slot, a crossed slot or recesses with tongue-like formations, such as for example TORX®, also referred to as a hexalobular internal.

This coupling piece is also preferably used for coupling an external motor drive which, of course, has to be equipped with a suitable catch. On the current state of the art are well-suited the so-called cordless screwdrivers. They have a built-in electrical energy source and a rotating clamping holder on their output shaft, into which a suitable catch can be quickly inserted.

It is a significant advantage of the inventive emergency hand crank drive that it is connected to the load shaft in its waiting position also. In order to prevent the rotary sliding piece from slipping off from the load shaft during shocks or changes in the position of the load shaft, the invention proposes that the travelling distance of the rotary sliding piece on the load shaft is limited by an inner stopper close to the load and an outer stopper, which is remote from the load. These stoppers can be inserted as spring washers into grooves on the load shaft. An alternative are clamping pieces, which are pushed over the shaft end into the desired position and are screwed there, doweled or held in grooves by retaining rings.

When the crank drive is subjected to regular changes in position and/or shocks, the rotary sliding piece moves back and forth between the stoppers, which can lead to undesired noise and increased wear. To avoid this, the invention proposes that a spring presses the rotary sliding piece against the inner stopper. This spring can be designed, for example, as a helical spring that winds concentrically around the load shaft and rests on the outer stopper.

In a further embodiment, the abovementioned spring is used to form a slip clutch which applies a limited holding torque to the load shaft. Such holding torque is useful under the following three conditions: The crank is in a waiting position, the load shaft and its coupling piece are freely rotatable and external influences can move the load shaft in an undesirable manner. An example of such an imposition is a self-locking, lightly loaded spindle, which is caused to rotate by external vibrations. For this case, a torque-limited slip clutch is useful on the load shaft. It prevents the load shaft from twisting unintentionally.

As a simple embodiment of the slip clutch, the invention proposes that the front side of the rotary sliding piece is corrugated and, under the pressure of the spring, engages in the face of the inner stopper which is shaped complementary to it. When an external torque interferes with the load shaft, the inner stopper is thereby pivoted. Thereupon, the corrugation which is formed in the face of the inner stopper—for example a wave trough—pushes the complementary shaped wave crest on the front side of the rotary sliding piece like a wedge in axial direction and thus compresses the spring. Thereby the spring generates a counterforce which is directed against the pivoting of the shaft. In this way, rotations due to relatively low, undesired external torques are prevented.

For connecting the crank arm to the rotary sliding piece any articulated connection is suitable. A very simple design is a key ring or a chain. Their disadvantages are, however, that the crank arm can oscillate freely and thereby in the case of vibrations can cause noise and damage. It is also disadvantageous that the user himself has to ensure a perfect guidance of the catch on the crank arm onto the coupling piece.

Therefore the invention prefers, that two gudgeons are shaped onto the rotary sliding piece. On these gudgeons two limbs of a fork are pivotally mounted. The centerpiece of the fork carries a catch and is connected to the crank arm. Preferably the centerline of the two gudgeons crosses the centerline of the load shaft and the centerline of the catch, provided that the coupling piece is arranged concentrically with the centerline of the load shaft. In this case, the centerlines of the load shaft, of the coupling piece and of the catch are identical, when the hand crank is in its operating state. Because these three elements will merge to become a shaft which passes through to the crank arm, many users will recognize the familiar configuration of a crank and therefore can lead the catch to the coupling piece without great mental effort.

A very interesting application of an inventive emergency hand crank drive is the lifting drive of a vertical telescopic support of a semi-trailer or other vehicle trailer. The spindle drive in these supports is usually driven by a hand crank. If the support is to be extended without load, the fastest possible movement, the so-called fast speed, is desired. If the support shall lift a fully loaded trailer, the torque from the hand crank has to be sufficient for that. This operating mode therefore requires a much higher gear ratio between the hand crank and the spindle drive—the so-called load speed—than in the unloaded fast speed. For the changeover between these two operating modes, most of the supports are equipped with a shift gearbox between the spindle and the hand crank.

Particularly semi-trailers however hardly needs the load speed in practice, because instead of changing the height of the loaded support, the height of the tractor to be coupled is adapted by means of its air suspension.

As a particularly advantageous application, the invention therefore proposes to equip the telescopic support of a semitrailer with an emergency hand crank according to the invention and to install as a lifting drive only a transmission with one fixed transmission ratio. Thereby the hitherto commonly used, complicated shifted gear box can be omitted. For the design of the lifting drive as a spindle drive, only the gear ratio of the former load speed is selected—usually about 1 mm stroke per revolution of the crank.

In normal operation, the support is moved by applying a cordless screwdriver. Thanks to the high revolution of its motor, the support is still moving sufficiently fast despite the high ratio in the spindle drive. In the rare cases of movement of the support under load, the hitherto familiar manual lifting of the semitrailer can be started immediately, thanks to the rapid availability of the inventive emergency hand crank drive.

In the following, further details and features of the invention are explained in more detail by means of an example. However, this example is not intended to limit the invention, but only to explain it. It is shown schematically:

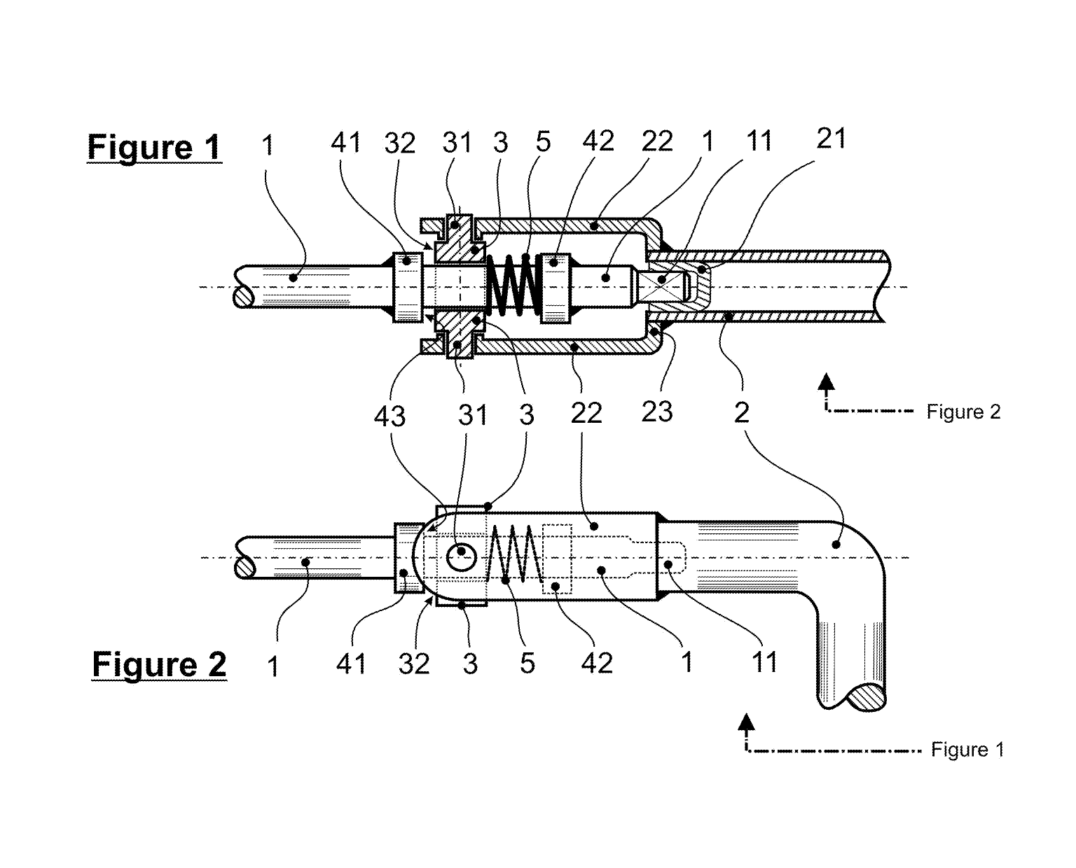

FIG. 1: Cross section of an emergency hand crank drive with the fork connecting the load shaft (1) with the fork and the rotary sliding piece (3)

FIG. 2: as FIG. 1, but crank turned further by 90°

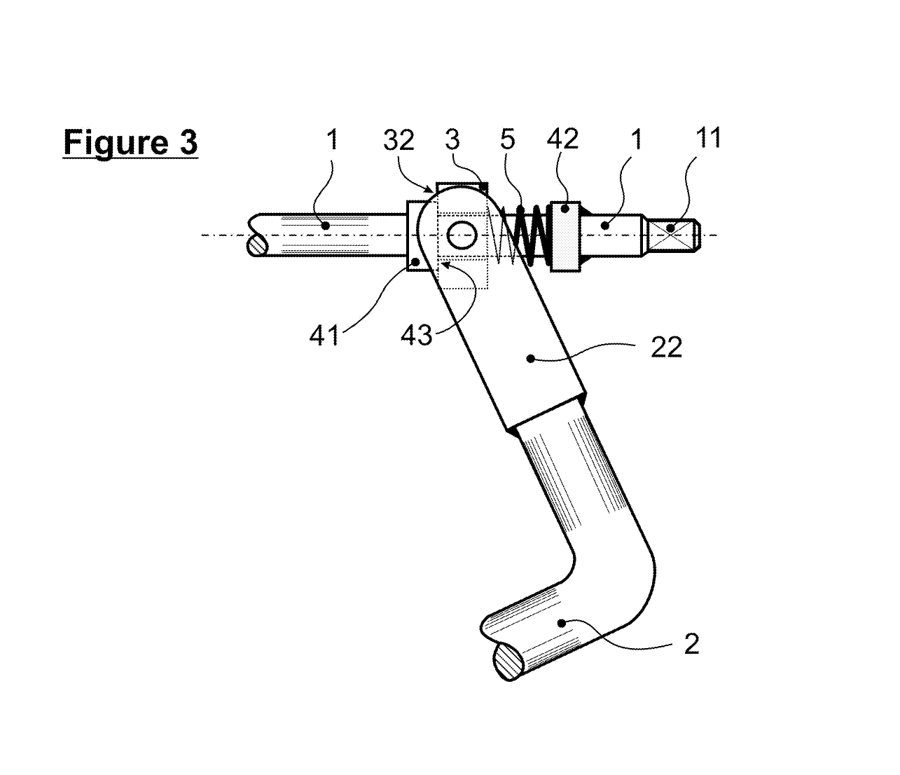

FIG. 3: as FIG. 2, but crank folded in

FIG. 1 shows from an emergency hand crank according to the invention only the end of the crank arm (2) and the therewith connected fork, which is connected to the load shaft (1). For the sake of clarity the largest part of the crank arm (2) and the attached handle are not plotted. Depicted is the active operating state of the emergency hand crank in which the catch (21), located inside of the tubular and angled end region of the crank arm (2), encompasses the coupling piece (11) of the load shaft (1).

Because in the illustrated embodiment the coupling piece (11) is integrally formed onto the end of the load shaft (1), the centerlines of the coupling piece (11), of the catch (21) and of the load shaft (1) are aligned.

In FIG. 1, the lateral flattening of the coupling piece (11) is marked with a diagonal cross. It is easy to understand that the catch (21), which is complementary to the coupling piece (11), can transmit a torque to the coupling piece (11) and thus further on to the load shaft (1).

Attached to the tubular end region of the crank arm (2) is a fork, which is graphically cut by its length. The two limbs (22) of the fork extend parallel to both sides of the load shaft (1). Into the end region of each limb (22) a bore is inserted. Into each bore a gudgeon (31) engages.

In FIG. 1 one can easily understand that the limbs (22) can be pivoted around the gudgeons (31). Thus the fork and the crank arm (2), which is attached to it, pivot also. The limbs (22) of the fork thus guide the crank arm (2) during the pivoting. In addition they also serve as a stabilization of the crank arm (2) in the operating state, by transferring forces onto the load shaft (1), which act vertically to the centerline of the hand crank.

FIG. 1 clearly shows that the rotary sliding piece (3) slides along the load shaft (1) and is pushed by the spring (5) in the direction of the inner stopper (41), whereby the spring (5) is resting on the outer stopper (42). On closer inspection it is to be seen that the rotary sliding piece (3) is still somewhat away from the inner stopper (41). Nevertheless even in this intermediate state torque can be transferred already from the crank arm (2) via the fork to the load shaft (1).

In FIG. 1 it is easy to understand, but not depicted that the rotary sliding piece (3) moves under the pressure of the spring (5) towards the inner stopper (41), so that the front side (32) of the rotary sliding piece (3) pretty soon will be pressed onto the face (43) of the inner stopper (41). FIG. 1 also not shows that the front side (32) and the face (43) are designed as a slip clutch, which transfers small and unwelcome torques from the load shaft (1) onto the rotary sliding piece and from there to the crank arm (2).

FIG. 2 shows the same operating state as in FIG. 1, but the crank arm (2) is rotated by 90° with respect to FIG. 1. Thus only one limb (22) from the fork on the crank arm (2) is visible, and only one gudgeon (31) on the rotary sliding piece (3) faces the observer. In this angular position of the crank arm (2), its bended end, which is fixedly connected to the fork, is particularly clearly recognizable.

In FIG. 3 can be seen the crank arm (2) and the fork attached thereto with its limb (22) from the same direction as in FIG. 2. The essential difference is that the emergency hand crank is folded down into a waiting position, so that the limbs (22) are now pivoted around the gudgeons (31). Due to the weight of the crank arm (2), which is shown here only partially, and the non-visible handle, the limb (22) has only pivoted out of the centerline of the load shaft (1) by about 65°. In FIG. 3 one can easily understand that the crank arm (2) can be pivoted further, as required, e.g. up to a holder.

The coupling piece (11) protrudes freely into the space so that an external drive, such as a motor, can be mounted thereon easily. By comparing FIG. 3 with FIG. 1 it is clear that the rotary sliding piece (3) does not move with a rotation of the load shaft (1), but slides on the load shaft (1), so that the limbs (22) and thus the entire emergency hand crank do not move.

In FIG. 3 it is clear that when the limbs (22) are pivoted back into the operating position, the rotary sliding piece (3) must be shifted on the load shaft (1) to the right against the force of the spring (5), i.e. away from the inner stopper (41), so that the catch (21), visible only in FIG. 1, will be moved in front of the coupling piece (11) and will be pressed thereon by the force of the spring (5).

In FIG. 3 it is obvious that the spring (5) presses the front side (32) of the rotary sliding piece (3) against the face (43) of the inner stopper (41). Not depicted is in FIG. 3, that the front side (32) and the face (43) are designed as a slip clutch. In the case of a very small, undesired, disturbing torque from the load on the load shaft (1), this slip clutch derives the disturbing torque on the rotary slide (3). From there, it is guided onto the limbs (22) and further onto the crank arm (2). When the crank arm (2) is fixed in the position of FIG. 3 by means of a device—not shown here—an undesired rotation of the load shaft (1) due to the undesired disturbance torque is prevented.

### LIST OF REFERENCE SIGNS

1 load shaft
11 coupling piece on load shaft 1
2 crank arm
21 catch, connected with crank arm 2
22 limb of a fork on crank arm 2
23 centerpiece of the fork on the crank arm 2
3 rotary sliding piece, can be pivoted and shifted on load shaft 1
31 gudgeon on rotary sliding piece
32 front side of rotary sliding piece
41 inner stopper on load shaft 1 for rotary sliding piece 3
42 outer stopper on load shaft 1 for rotary sliding piece 3
43 face of the inner stopper 41
5 spring, rests on outer stopper 42, pushes the rotary sliding piece 3 towards the inner stopper 41

1. Emergency hand crank drive consisting of a load shaft (1) that is to be made to rotate, and a crank arm (2) hingedly connected to said load shaft (1), and a coupling piece (11) on said load shaft (1) and a catch (21), which is fixedly connected to said crank arm (2) and which has a shape that is complementary to the shape of said coupling piece (11) and which can be releasably connected to said coupling piece (11),
wherein
a rotary sliding piece (3) is mounted on said load shaft (1) in such a way as to be movable in the longitudinal direction of said load shaft (1) and be rotatable around the longitudinal direction thereof and said crank arm (2) is hingedly secured to said rotary sliding piece (3).

2. Emergency hand crank drive, according to claim 1,
wherein said coupling piece (11) is arranged concentrically on said load shaft (1).

3. Emergency hand crank drive, according to claim 1, wherein a different external tool or a motor can be placed on said coupling piece (11) as an alternative to said crank arm (2).

4. Emergency hand crank drive, according to claim 1, wherein
the travelling distance of said rotary sliding piece (3) on said load shaft (1) is limited by an inner stopper (41) close to the load and an outer stopper (42) which is remote from the load.

5. Emergency hand crank drive, according to claim 4,
wherein
a spring (5) is supported from said outer stopper (42) and said spring (5) presses said rotary sliding piece (3) against said inner stopper (41).

6. Emergency hand crank drive, according to claim 5,
wherein
the front side (32) of said rotary sliding piece (3), which faces said inner stopper (41), is corrugated and engages under the pressure of said spring (5) into the face (43) of said inner stopper (41), which is formed complementary to said front side (32), or said front side (32) and said face (43) are designed as a different type of torque-limited slip clutch.

7. Emergency hand crank drive, according to claim 1, wherein
two gudgeons (31) are shaped onto said rotary sliding piece (3) and on said gudgeons (31) the two limbs (22) of a fork are pivotally mounted, whereby the centerpiece (23) of said fork carries said catch (21) and said centerpiece (23) is connected to said crank arm (2).

8. Emergency hand crank drive, according to claim 1, wherein
said load shaft (1) drives the lifting drive of a vertical telescopic support of a semi-trailer or other vehicle trailer.

9. Emergency hand crank drive, according to claim 8,
wherein
the lifting drive is a transmission having a fixed ratio.
